(19) United States
(12) Patent Application Publication
(10) Pub. No.: US 2019/0366269 A1
(43) Pub. Date: Dec. 5, 2019

(54) REVERSE OSMOSIS MEMBRANE

(71) Applicants: SK INNOVATION CO., LTD., Seoul (KR); KOREA UNIVERSITY RESEARCH AND BUSINESS FOUNDATION, Seoul (KR)

(72) Inventors: Sang Hyun PARK, Daejeon (KR); Min Sang PARK, Daejeon (KR); Jung-hyun LEE, Seoul (KR); Sang Hee PARK, Seoul (KR); Soon Jin KWON, Daejeon (KR)

(21) Appl. No.: 16/315,934

(22) PCT Filed: Jul. 6, 2017
(86) PCT No.: PCT/KR2017/007238

§ 371 Date: Jan. 7, 2019

(30) Foreign Application Priority Data
Jul. 7, 2016 (KR) 10-2016-0086103

(51) Int. Cl. B01D 61/02; B01D 71/26; B01D 71/56; B01D 69/06; B01D 69/12; C02F 1/44

(52) U.S. Cl. CPC B01D 61/025; B01D 71/26; C02F 1/441; B01D 69/06; B01D 69/12; B01D 71/56

(57) ABSTRACT

Provided is a reverse osmosis membrane using a hydrophilized polyolefin-based microporous membrane.

A reverse osmosis membrane according to the present invention may provide a large treatment area per unit volume by using a thin film type support, thereby improving water treatment performance.

### TECHNICAL FIELD

The present invention relates to a reverse osmosis membrane using a thin polyolefin-based microporous membrane.

### BACKGROUND ART

Osmosis is a phenomenon in which a solvent moves from a solution having a low solute concentration to a solution having a high solute concentration by passing through a semi-permeable membrane and is caused by a difference in chemical potential of the solvents present in both sides of the membrane. When the chemical potential of both sides of the membrane become equal, the movement of the solvent is stopped and the difference in a osmotic pressure corresponding to a water head difference is generated. In this case, when a pressure over the difference in a osmotic pressure is applied to the solution having a high solute concentration, contrary to osmosis, the solvent flows back from the solution having a high solute concentration to the solution having a low solute concentration, which is called a reverse osmosis. Various types of salts or organic materials may be separated through the semi-permeable membrane by using a pressure gradient as driving force, according to the principle of a reverse osmosis. Since the reverse osmosis separation membrane using this reverse osmosis is not operated depending on molecule size, there is less deposits of organic material unlike microfiltration or ultrafiltration, resulting in a longer lifetime of the membrane. As a result, the reverse osmosis membrane has been used to separate molecular-level materials, and remove salts from salt water or sea water, thereby supplying domestic, architectural and industrial water.

One of the common types of reverse osmosis membranes is a polyamide-based membrane formed of a porous support and a polyamide thin film formed on the porous support. Specifically, the polyamide-based membrane has been manufactured by forming a polysulfone layer on a non-woven fabric to form microporous support, and interfacially polymerizing the microporous support with a polyfunctional amine and a polyfunctional acyl halide to form a polyamide active layer. According to this method of manufacturing, since a non-polar solution and a polar solution come in contact with each other, polymerization occurs only at the interface thereof, such that a very thin polyamide active layer is formed.

The reverse osmosis membrane including a polyamide-based thin film as an active layer is highly stable against pH changes, may operate at low pressures and has a high salt rejection of 90% or more. However, since the reverse osmosis membrane has relatively very low permeability, the application thereof was extremely limited.

Thus, in order to enhance the application scope and cost effectiveness, there is a need to develop technique for improving the permeability allow excess water to pass through while having the rejection in an appropriate range satisfying the salt rejection of the reverse osmosis membrane of 40 to 90%.

However, in a conventional reverse osmosis membrane using a non-woven fabric, the support is thick with a thickness of 100 to 200 μm and thus the membrane is limited in providing a large treatment area per unit volume. Therefore, there are limitations in improving permeability.

In addition, staple fibers protruding from a surface of the non-woven fabric may cause the following drawbacks: the surface is uneven resulting in a smoothness being remarkably poor; even a polymer solution such as polysulfone is difficult to be applied uniformly; and a polymer layer may be finely separated from the non-woven fabric layer may cause cracking, thereby significantly reducing a durability of the reverse osmosis membrane.

Further, an additional process for forming polysulfone layer on the non woven fabric is required, and when the polysulfone layer is applied, since an organic solvent having a high boiling point such as dimethylformamide is used, and the drying time is prolonged, thereby resulting in low productivity.

Furthermore, the reverse osmosis membrane should have excellent chemical resistance in order to be widely used for but also seawater, not only for general salt water, but, the polysulfone layer is insufficient in chemical resistance. Thus, the conventional reverse osmosis membrane has a problem that its chemical resistance is insufficient to be used for separation of seawater and an organic solvent.

### DISCLOSURE

### Technical Problem

An object of the present invention is to provide a reverse osmosis membrane capable of providing a large treatment area per unit volume by using a thin film type microporous membrane instead of a conventional non-woven fabric, thereby improving water treatment performance.

Another object of the present invention is to provide a reverse osmosis membrane having an excellent surface smoothness, a good durability, and excellent chemical resistance and mechanical physical properties as compared with the conventional reverse osmosis membrane made of the non-woven fabric.

Still another object of the present invention is to provide a reverse osmosis membrane having lower production cost and thus being easy to be commercialized as compared with the conventional non-woven fabric.

### Technical Solution

In one general aspect, there is provided a reverse osmosis membrane including a polyamide active layer formed on a hydrophilized polyolefin-based microporous membrane, wherein the polyolefin-based macroporous membrane has a space ratio of 20 to 70% a maximum pore size measured by a bubble point method of 0.1 μm or less, and a product of a tensile strength and a thickness in at least one of a transverse direction and a longitudinal direction of 0.3 kgf/cm or more.

The polyolefin-based microporous membrane may have a contact angle of water of 90 degrees or less.

The polyolefin-based microporous membrane may be a film or a sheet.

The polyolefin-based microporous membrane may be selected from a single layer microporous membrane formed of any one selected from a polyethylene, a polypropylene, and a mixture thereof; a composite microporous membrane having two or more layers in which the polyethylene and the polypropylene are alternately stacked; and a multilayer microporous membrane in which the polyethylene or the polypropylene is stacked in two or more layers.

The hydrophilization may be performed by any one method selected from formation of a coating layer by applying any one selected from a surfactant, a surface active agent, a wetting agent, a polymer solution containing inorganic particles, and a hydrophilic polymer, plasma treatment, UV-ozone treatment, corona discharge, surface foaming, and grafting with a hydrophilic polymer by plasma treatment.

The polyamide active layer may be formed by interfacial polymerization of an aqueous solution containing a polyfunctional amine and an organic solution containing a polyfunctional acyl halide.

The reverse osmosis membrane may have a salt rejection of 97% or more and a permeate flux of 35 L/m²hr or more.

### Advantageous Effects

The reverse osmosis membrane of the present invention uses a thin film type support to provide a large treatment area per unit volume. Thus, the permeate flux is increased and the salt rejection is excellent, thereby improving the water treatment performance. In addition, as the polyolefin-based microporous membrane is used, the surface smoothness, a durability, a chemical resistance and a mechanical physical property are excellent.

### Best Mode

Hereinafter, a reverse osmosis membrane according to the present invention and a method of manufacturing the same will be described in detail with reference to specific examples. The following specific examples and embodiments are merely references for explaining the present invention in detail, but the present invention is not limited thereto and may be embodied in various forms.

In addition, all technical and scientific terms have the same meanings as commonly understood by those skilled in the art to which the present invention pertains, unless defined otherwise. The terms used herein are for effectively describing particular specific examples and are not intended to limit the present invention.

The term “hydrophilic” used herein refers to an ability to be wet-out with water or an aqueous solution. The term “wetting” refers to an ability to allow water or an aqueous solution to more easily penetrate into or disperse on the surface of other materials. Generally, a polyolefin is hydrophobic, and the term “hydrophobic” refers to the ability to be not wet-out with water or an aqueous solution. More specifically, the term hydrophobic used herein refers to a contact angle of water of greater than 90 degrees. The term hydrophilic refers to the contact angle of water angle of 90 degrees or less, and more preferably 80 degrees or less.

According to an exemplary embodiment of the present invention, it is characterized in that a conventional porous support in a woven or non-woven fabric type is replaced with a polyolefin-based microporous membrane of a film type or a sheet type. The term “sheet type” refers to a microporous membrane manufactured by melt extruding or casting a polyolefin-based resin. The term “film type” refers to a microporous membrane manufactured by casting and stretching a polyolefin-based resin, or by melt extruding a composition containing a polyolefin-based resin and a diluent, followed by stretching. That is, the polyolefin-based microporous membrane of the present invention may be manufactured by a dry method or a wet method.

The inventors have completed the present invention in view of the fact that a porous membrane manufactured by using a polyolefin-based semi-crystalline polymer as a raw material to form pores through phase separation or cracks at intercrystalline interfaces, and securing strength through a stretching process, may be capable of forming a polyamide active layer and supporting a reverse osmosis operating pressure in a specific pore structure and within a physical property range.

According to an embodiment of the present invention, the polyolefin-based microporous membrane refers to a microporous membrane manufactured by mixing a polyolefin-based resin and a diluent, followed by melt extruding, stretching, and then extraction of the diluent, or a microporous membrane of which a surface of the microporous membrane is hydrophilcally modified. Alternatively, inorganic particles may be further included, if necessary.

According to an embodiment of the present invention, it is preferred that the polyolefin-based microporous membrane has a contact angle of water of 90 degrees or less, and more specifically, a contact angle of water of 0 to 90 degrees, since these values are suitable for improving water treatment performance. Typically, since the polyolefin resin is hydrophobic, the interface adhesion of the polyamide is weak when the microporous membrane is manufactured using the polyolefin resin. Therefore, in order to improve the interfacial adhesion of the polyamide, it is preferable to perform the hydrophilization for modifying the surface to be hydrophilic. In addition, in the range of the contact angle of water of 90 degrees or less, the water treatment performance may be further improved.

More specifically, the hydrophilization of the surface of the polyolefin-based microporous membrane may be performed so that the contact angle of water becomes 90 degrees or less. The hydrophilization may be surface-modified to be hydrophilic by applying any one method selected from formation of a coating layer by applying any one selected from a surfactant, a surface active agent, a wetting agent, a polymer solution containing inorganic particles, and a hydrophilic polymer, plasma treatment, UV-ozone treatment, corona discharge, surface foaming, and grafting with a hydrophilic polymer by plasma treatment, but is not limited thereto.

According to an embodiment of the present invention, the polyolefin-based resin constituting the polyolefin-based microporous membrane may be a homopolymer or a copolymer formed of at least one polymer selected from the group consisting of ethylene, propylene, 1-butene, 1-hexene, 1-octene, 1-pentene, 4-methyl-1-pentene, 1-hexene, 1-heptene, 1-decene, 1-undecene, 1-dodecene, norbornene and ethylidene norbornene. The homopolymer may be a polyethylene or a polypropylene. More specifically, the polyethylene may be a single polyethylene or a polyethylene mixture formed of ethylene alone or a combination of ethylene and an alpha-olefin comonomer having 3 to 8 carbon atoms. In addition, the polypropylene may be a single propylene or a propylene mixture formed of propylene alone or a combination of propylene, ethylene and an alpha olefin having 4 to 8 carbon atoms, having a melting temperature of 160 to 180° C. In addition, in the present invention, the polyethylene polymer and the polypropylene polymer may be mixed and used, and any polyolefin-based resin may be used without limitation.

It is preferred to use the polyolefin-based resin having a weight average molecular weight of 100,000 to 1,000,000 g/mol since the above range may improve a mechanical strength and a durability, but is not limited thereto.

According to an embodiment of the present invention, an organic liquid compound thermally stable at an extrusion processing temperature, including an aliphatic or cyclic hydrocarbon such as nonane, decane, decalin, and paraffin oil, and phthalic acid ester such as dibutyl phthalate, dioctyl phthalate may be used as the diluent. Most preferably, a paraffin oil which is harmless to the human body and has a high boiling point and less volatile components is suitable, and still more preferably, a paraffin oil which has a kinetic viscosity of 20 to 200 cSt at 40° C.

In content of the diluent used herein, when the content of the polyolefin resin is 20 to 50 wt % and the content of the diluent is 50 to 80 wt %, a kneading property between the polyolefin resin and the diluent is excellent and the polyolefin-based resin is not thermodynamically kneaded with the diluent, and a film being excellent in stretchability may be manufactured.

In addition, inorganic materials may be further included, if necessary. The inorganic material may be any one or a mixture of two or more selected from the group consisting of silicon dioxide (SiO₂), aluminum oxide (Al₂O₃), calcium carbonate (CaCO₃), titanium dioxide (TiO₂), SiS₂, SiPO₄, MgO, ZnO and BaTiO₃, but is not limited thereto. The inorganic material may have an average particle size of 0.01 to 5 μm. It is preferred because when the average particle size is within the above range, strength of the film is excellent and the pore size after stretching is suitable for application to a reverse osmosis membrane, but is not limited thereto.

In addition, general additives for improving specific functions such as an oxidation stabilizer, a UV stabilizer, an antistatic agent, an organic nucleating agent, and an inorganic nucleating agent may be further added, if necessary.

According to an embodiment of the present invention, the polyolefin-based microporous membrane may be selected from a single layer microporous membrane formed of any one selected from a polyethylene, a polypropylene, and a mixture thereof; a composite microporous membrane having two or more layers in which the polyethylene and the polypropylene are alternately stacked; and a multilayer microporous membrane in which the polyethylene or the polypropylene is stacked in two or more layers.

According to an embodiment of the present invention, the polyolefin-based microporous membrane may have a thickness of 5 to 50 μm, but is not limited thereto. There are advantages that in this range, a reverse osmosis operating pressure may be supported; since the membrane is thin, the permeate flux may be increased; and a continuous process for forming the polyamide active layer is easy to operate.

In addition, a space ratio is preferably 20 to 70%. When the space ratio is within the above range, the permeate flux is excellent, strength of the support is excellent, and the permeate flux is improved. In addition, the maximum pore size measured by the bubble point method is preferably 0.1 μm or less, and more specifically, the maximum pore size is preferably 10 to 100 nm. When the pore size is within the above range, the densities of the polyamide active layers are not lowered, such that the effect of an excellent salt rejection may be exerted. When the maximum pore size is greater than 0.1 μm, pinhole defects may occur in the polyamide active layer and the physical properties of the salt rejection of 97% or more may not be achieved. In addition, to support the reverse osmosis operating pressure, it is preferable that the product of a thickness and a tensile strength in at least one of a longitudinal direction and a transverse direction is 0.3 kgf/cm or more, more preferably 0.3 to 10 kgf/cm.

According to an embodiment of the present invention, the polyamide active layer may be formed by interfacial polymerization of an aqueous solution containing a polyfunctional amine and an organic solution containing a polyfunctional acyl halide.

The aqueous solution containing the polyfunctional amine is obtained by dissolving the polyfunctional amine in water, and the polyfunctional amine compound may be at least one polyfunctional amine such as an aromatic polyfunctional amine which is unsubstituted or substituted with an alkyl group having 1 to 6 carbon atoms, an alkoxy group having 1 to 6 carbon atoms, a hydroxyalkyl group, a hydroxyl group or a halogen atom; or benzidine, diaminobenzdine; or a benzidine derivative and a naphthalene diamine substituted with an alkyl or a halogen atom, and the like. More specific examples of the polyfunctional amine may include o-phenylenediamine, m-phenylenediamine, p-phenylenediamine, 1,3,5-benzenetriamine, 4-chloro-1,3-phenylenediamine, 5-chloro-1,3-phenylenediamine, 3-chloro-1,4-phenylenediamine; an aromatic polyfunctional amine substituted with an alkyl group such as a methyl group and an ethyl group, an alkoxy group such as a methoxy group and an ethoxy group, a hydroxyalkyl group, a hydroxyl group or a halogen atom, and the like, as derivatives thereof; benzidine, diaminobenzidine; or a benzidine derivative and a naphthalene diamine substituted with an alkyl or halogen atom, and the like, but is not necessarily limited thereto. Among them, it is preferred to use m-phenylenediamine, p-phenylenediamine, 1,3,6-benzenetriamine, 4-chloro-1,3-phenylenediamine, 6-chloro-1,3-phenylenediamine, 3-chloro-1,4-phenylenediamine or a mixture thereof, and it is most preferred to use m-phenylenediamine. The polyfunctional amine compound may be included in an amount of 0.1 to 20 wt %, and more preferably 1.0 to 10 wt % in the aqueous solution.

In addition, the organic solution containing the polyfunctional acyl halide obtained by dissolving the polyfunctional acyl halide compound in an aliphatic hydrocarbon-based organic solution, and the polyfunctional acyl halide compound is an aromatic compound having 2 to 3 carboxylic acid halides, and examples thereof may include trimesoyl chloride, isophthaloyl chloride, terephthaloyl chloride, or a mixture thereof, but is not limited thereto. The polyfunctional acyl halide compound may be included in an amount of 0.01 to 5 wt % in the organic solution.

In addition, the aliphatic hydrocarbon-based organic solution may be n-hexane.

The reverse osmosis membrane of the present invention may simultaneously satisfy the physical property in which the salt rejection is 97% or more, and more specifically 97 to 99.9%, the permeate flux is 35 L/m²hr or more, and more specifically 35 to 45 L/m²hr.

Hereinafter, a method of manufacturing the reverse osmosis membrane of the present invention will be described in detail.

(1) Step of Manufacturing Film Type Polyolefin-based Microporous Membrane

Accordingly to an embodiment of the present invention, more specifically, a method of manufacturing the polyolefin-based microporous membrane by a wet method may include the following steps: (a) injecting a polyolefin-based resin (component 1) and a diluent (component 2) capable of achieving liquid-liquid phase separation with the polyolefin resin into an extruder, kneading and extruding the components 1 and 2 to produce a melt; (b) passing the melt through an section at which an extrusion temperature is lower than an liquid-liquid phase separation temperature, to proceed the liquid-liquid phase separation to produce a sheet type; (c) stretching the sheet; and (d) extracting the diluent (component 2) from the sheet and drying the sheet.

In addition, a method of manufacturing the polyolefin-based microporous membrane by a drying method may be a method of melt extruding the polyolefin-based resin, followed by casting or blowing, and stretching.

More specifically, the polyolefin-based microporous membrane may be manufactured by methods described in Korean Patents Nos. 10-0943697, 10-0943234, 10-0943235, 10-0943236, 10-1199826, 10-1288803, 10-1432146, 10-1437852, 10-1269203, 10-1404451, 10-1394622, 10-1404461, 10-0976121, 10-1004580, 10-1269207, 10-1394624, and the like, but is not limited thereto.

(2) Step of Hydrophilizing Microporous Membrane

According to an embodiment of the present invention, the surface of the microporous membrane is hydrophilized, thereby making it possible to modify a hydrophobic surface to a hydrophilic surface with the contact angle of water of 90 degrees or less.

The hydrophilization may be performed by any one method selected from formation of a coating layer by applying any one selected from a surfactant, a surface active agent, a wetting agent, a polymer solution containing inorganic particles, and a hydrophilic polymer, plasma treatment, UV-ozone treatment, corona discharge, surface foaming, and grafting with a hydrophilic polymer by plasma treatment, and not limited as long as it is a commonly known method.

In addition, in the hydrophilization, the polyolefin-based microporous membrane may be used without limitation as long as the contact angle of water of the polyolefin microporous membrane is 90 degrees or less.

An example of the surfactant may include polyethylene glycol diolate, nonylphenoxypoly (ethyleneoxy) ethanol, triethylene glycol divinyl ether, and a mixture thereof, but is not limited thereto.

In the case of the formation of a coating layer by applying the hydrophilic polymer, the hydrophilic polymer may be polyvinyl alcohol, but is not limited thereto.

In the case of the method of grafting with a hydrophilic polymer by the plasma treatment, the hydrophilic polymer may be any hydrophilic acrylic polymer selected from the group consisting polyacrylonitrile, polyacrylic acid and polyacrylate, but not limited thereto. In the surface modification method of the polyolefin microporous membrane by the plasma coating method, a pressure in an activated plasma reactor may be 0.01 to 1,000 mTorr and a flux of a reaction gas in the activated plasma reactor may be 10 to 1,000 sccm.

Typically, since the polyolefin resin which has the contact angle of water of 120 degrees or more is hydrophobic, the interface adhesion of the polyamide is weak when the microporous membrane is manufactured using the polyolefin resin. Therefore, in order to improve the interface adhesion of the polyamide, it is preferable to modify the surface to be hydrophilic. In addition, in the range of the contact angle of water of 90 degrees or less, the water treatment performance may be further improved.

(3) Step of Interfacial Polymerization of Surface

The hydrophilized polyolefin-based microporous membrane is immersed in an aqueous polyfunctional amine solution for 5 seconds to 5 minutes.

Next, the polyolefin-based microporous membrane immersed in the aqueous polyfunctional amine solution is removed, and then an excess of aqueous polyfunctional amine solution is removed. The removal process may be carried out by compressing using a rubber roll or by using a rubber blade wiper or an air knife, and the like.

Then, the polyolefin-based microporous membrane is immersed in an aliphatic hydrocarbon-based organic solution in which a polyfunctional acyl halide is dissolved for 5 seconds to 5 minutes. At this time, the polyamide is produced by reacting the polyfunctional amine and the polyfunctional acyl halide according to the interfacial polymerization, whereby a polyamide active layer is formed on the surface of the polyolefin-based microporous membrane.

(4) Step of Removing and Drying Residual Solvent

Lastly, a polyamide reverse osmosis separation membrane may be obtained by (trying and then washing polyolefin-based microporous membrane on which the polyamide active layer is formed. The drying and washing steps are not limited particularly and those conventionally used in the art may be applied. For example, the polyolefin-based microporous membrane may be dried at ambient temperature, and when the solvent is considered to have evaporated to some extent, the polyolefin-based microporous membrane may be completely dried at 30 to 120° C. for 30 seconds to 10 minutes. After that, the thin membrane is cooled again to ambient temperature, washed in an aqueous sodium carbonate solution at 20 to 80° C. for 30 minutes to 1 hour, and stored in pure water, thereby producing a polyamide reverse osmosis membrane.

Hereinafter, for a more detailed description, the present invention will be described based on Examples and Comparative Examples, however, the present invention is not limited to the following Examples.

The following physical properties were measured by measurement methods below.

1. Permeate Flux (L/m²hr) and Salt Rejection (%)

The measurement of the permeate flux and the salt rejection was performed by using an aqueous sodium chloride solution of 2,000 ppm in a cross-flow mode under a condition of a temperature of 20° C., a flow rate of 3.0 L/min, and a reverse osmosis operating pressure of 15.5 kgf/cm². A reverse osmosis cell device used in the membrane evaluation includes a flat permeability cell, a high-pressure pump, a reservoir, and a cooling device. An effective permeation area is 100 cm².

The flux is expressed by a flux value per unit area and unit pressure of the flux of the obtained produced water, and the salt rejection is a value showing removal performance and obtained by measuring of an ionic conductivity (TDS) of the produced water, which may be obtained by the following method

Salt rejection (%) ={1−(conduthvity value of produced water/conductivity value of raw water)}×100

2. Thickness of Microporous Membrane

The TESA-μ HITE product was used as a contact thickness gauge with a thickness accuracy of 0.1 μm.

3. Space Ratio (%) of Microporous Membrane

The space ratio was calculated by calculating a space within the microporous membrane.

A sample having a width of A cm, a length of B cm, and a thickness of T cm was prepared, and a mass of the sample was measured, thereby calculating the space ratio through a ratio of a weight of the resin having the same volume and a weight of the microporous membrane.

The space ratio was calculated from Equation 1 below. Both A and B were cut in the range of 5 to 20 cm.

Space ratio={((A×B×T)−(M/p)/(A×B×T)}×100 [Equation 1]

wherein T is a thickness of the sample in cm.

M is the weight of the sample in g,

p is a density of the resin in q/cm³.

4. Maximum Pore Size of Microporous Membrane

The maximum pore size was measured by a porometer (CFP-1500-AEL from PMI) according to ASTM F316-03. The maximum pore size was measured by a bubble point method. In order to measure of the pore size, a Galwick solution (surface tension; 15.9 dyne/cm) supplied by PMI was used.

5. Thickness×Tensile Strength of Microporous Membrane

A tensile strength was measured according to ASTM D882 and the tensile strength was measured at a cross-head speed of 500 mm/min by using a UTM (universal testing machine).

The unit of tensile strength is kgf/cm².

The thickness of the microporous membrane was then converted into the unit of cm, and multiplied by the tensile strength.

The unit of product of the tensile strength and thickness is kgf/cm.

6. Contact Angle of Water of Microporous Membrane

The contact angle of water was measured by a contact angle goniometry (PSA 100, KRUSS GmbH). The contact angle of water was measured by dropping 3 μl of drops of water on a measurement surface with a micro-injector. Five drops of water were dropped on each surface of the microporous membranes manufactured in Examples and Comparative Examples, and the contact angle was measured with a microscope. Average values of the measured contact angle of water are shown in Table 1.

7. Weight Average Molecular Weight

A molecular weight of the polymer was measured at 140° C. by using 1,2,4-trichlorobenzene (TCB) as a solvent and using a high-temperature permeation chromatography (GPC) from Polymer Laboratory. As a standard sample for molecular weight measurement, polystyrene was used.

### EXAMPLE 1

1) Manufacture of Microporous Membrane 35 wt % of high-density polyethylene having a weight average molecular weight of 3.8×10⁵ g/mole and 65 wt % of a diluent in which dibutyl phthalate and a paraffin oil having a kinematic viscosity of 160 cSt at 40° C. are mixed at a weight ratio of 1:1 were mixed. The composition was extruded using a biaxial compounder equipped with a T-die at 245° C., and passed a section set at 175° C. to induce phase separation of a polyethylene and the diluent as a single phase, thereby manufacturing a sheet using a casting roll. The sheet manufactured using a sequential biaxial stretching machine was stretched 7.0 times in a longitudinal direction and a transverse direction at a stretching temperature of 127° C., respectively. Following stretching, a heat setting temperature was 130° C., a heat setting width was 1 times in a preheating section, 1.3 times in a hot stretching section, and 1.2 times in a final heat setting section. Physical properties of the manufactured polyethylene macroporous membrane were measured and shown in Table 1 below.

2) Hydrophilization of Microporous Membrane

A surface of the manufactured microporous membrane was corona-treated so as to have 59 degrees of the contact angle of water.

The corona treatment was carried out with a gap of 2 mm between the electrodes and the membrane at a speed of 0.5 m/min under a voltage of 250 V by using a CTW0212 from Wedge, and the results were shown in Table 2.

3) Manufacture of Reverse Osmosis Membrane

Metaphenylenediamine (MPD, 99%) was dissolved in deionized water (Mili-Q water, 18 MΩ·cm) to produce 2 wt % of an aqueous MPD solution. Next, the hydrophilized microporous membrane was immersed in the aqueous MPD solution for 1 minute, and removed, and then the residual solution was removed using a rubber roller.

Then, trimesoyl chloride (TMC, 98%) was dissolved in n-hexane (98%) produce 0.1 wt % of a TMC organic solution, the reverse osmosis membrane support from which the residual solution was removed was immersed in the TMC organic solution for 1 minute, removed, washed with n-hexane, and dried at ambient temperature for 5 minutes.

The reverse osmosis membrane support was washed with an aqueous solution containing 0.2 wt % of sodium carbonate for 30 minutes, followed by washing with pure water again at ambient temperature, thereby producing a reverse osmosis membrane.

Physical properties of the manufactured reverse osmosis membrane were evaluated and shown in Table 1 below.

### EXAMPLES 2 to 6

Examples 2 to 6 were performed in the same manner as in Example 1, except that the thickness, the space ratio, the maximum pore size, the product of the thickness and the tensile strength, and the contact angle of water were changed by varying the production conditions of the polyolefin microporous membrane and the conditions of the corona treatment, as shown in Table 1 below.

Physical properties of the manufactured polyethylene microporous membrane and the reverse osmosis membrane were evaluated and shown in Table 1 below. The respective corona treatment conditions were separately shown in Table 2.

### EXAMPLE 7

1) Manufacture of Microporous Membrane

A casting film made of a homopolypropylene having a melt flow index of 2.0 g/10 minutes at 230° C. was heat-treated, followed by 10% stretching at 50° C. and stretching 150% stretching at 130° C. in a uniaxial direction to obtain a polypropylene microporous membrane.

The manufactured polypropylene microporous membrane was corona treated and hydrophilized in the same process as in Example 1 to manufacture a reverse osmosis membrane.

Physical properties the manufactured polyethylene microporous membrane and the reverse osmosis membrane were evaluated and shown in Table 1 below. The corona treatment conditions were separately shown in Table 2.

### Comparative Examples 1 to 3

Comparative Examples 1 to 3 were performed using the same raw materials as in Example 1, and the thickness, the space ratio, the maximum pore size, the product of the thickness and the tensile strength, and the contact angle of water were changed as shown in Table 1 below by varying the production conditions of the polyolefin membrane and the conditions of the corona treatment.

Physical properties of the manufactured polyethylene microporous membrane and the reverse osmosis membrane were evaluated and shown in Table 1 below. The corona treatment conditions were separately shown in Table 2.

### Comparative Example 4

Comparative Examples 4 was performed using the same raw materials as in Example 7, and the thickness, the space ratio, the maximum pore size, the product of the thickness and the tensile strength, and the contact angle of water were changed as shown in Table 1 below by varying the production conditions of the polyolefin microporous membrane and the conditions of the corona treatment.

Physical properties of the manufactured polyethylene microporous membrane and the reverse osmosis membrane were evaluated and shown in Table 1 below. The corona treatment conditions were separately shown in Table 2.

### Comparative Example 5

Comparative Example 5 was performed in the same manner as in Example 1, except that the polyolefin microporous membrane was not corona treated to manufacture a reverse osmosis membrane.

The physical properties of the manufactured polyethylene microporous membrane and the reverse osmosis membrane were evaluated and shown in Table 1 below.

### Comparative Example 6

Comparative Example 6 was performed in the same manner as in Example 3, except that the polyolefin microporous membrane was not corona treated to manufacture a reverse osmosis membrane.

Physical properties of the manufactured polyethylene microporous membrane and the reverse osmosis membrane were evaluated and shown in Table 1 below.

TABLE 1

| | Polyolefin Microporous Memebrane Properties | | | | | | | | |
|---|---|---|---|---|---|---|---|---|---|
| | | | | Thickness × | | Contact | | | |
| | | | Maximum | Tensile strength | | Angle | | | |
| | | Space | Pore | (kgf/cm) | | of | Salt | Permeate | |
| | Thickness | Ratio | Size | Longitudinal | Transverse | Water | Rejection | Flux | |
| | (μm) | (%) | (nm) | Direction | Direction | (°) | (%) | (L/m2hr) | Remake |
| Example 1 | 20 | 46 | 50 | 3.9 | 3.5 | 59 | 99.2 | 41.9 | — |
| Example 2 | 20 | 46 | 50 | 13.9 | 3.5 | 87 | 98.4 | 40.1 | — |
| Example 3 | 20 | 62 | 74 | 3.2 | 1.3 | 63 | 97.1 | 37.6 | — |
| Example 4 | 30 | 70 | 88 | 2.4 | 1.3 | 60 | 97.5 | 38.1 | — |
| Example 5 | 5 | 21 | 28 | 1.5 | 1.2 | 53 | 99.3 | 42.5 | — |
| Example 6 | 25 | 66 | 99 | 2.6 | 1.0 | 72 | 97.8 | 39.8 | — |
| Example 7 | 25 | 39 | 51 | 5.5 | 0.3 | 75 | 99.0 | 40.3 | — |
| Comparative | 35 | 72 | 92 | 2.2 | 0.4 | 62 | 75.2 | 36.2 | — |
| Example 1 | | | | | | | | | |
| Comparative | 20 | 64 | 103 | 2.0 | 1.2 | 63 | 36.8 | 44.2 | Pinhole |
| Example 2 | | | | | | | | | Generation |
| Comparativc | 5 | 19 | 24 | 1.6 | 1.4 | 57 | 99.4 | 17.6 | — |
| Example 3 | | | | | | | | | |
| Comparative | 16 | 43 | 58 | 2.6 | 0.24 | 77 | Not | Not | Fracture |
| Example 4 | | | | | | | Measurable | Measurable | Generation |
| Comparative | 20 | 46 | 50 | 3.9 | 3.5 | 120 | 7.0 | 13.6 | — |
| Example 5 | | | | | | | | | |
| Comparative | 20 | 62 | 74 | 3.2 | 1.5 | 119 | 26.3 | 0.7 | — |
| Example | | | | | | | | | |

TABLE 2

| | | Gap Between | |
|---|---|---|---|
| | Voltage | electrode and | Throughput rate |
| | (V) | Membrane (mm) | (m/min) |
| Example 1 | 250 | 2 | 0.5 |
| Example 2 | 170 | 5 | 2.0 |
| Example 3 | 170 | 2 | 2.0 |
| Example 4 | 250 | 2 | 1.5 |
| Example 5 | 250 | 2 | 0.2 |
| Example 6 | 250 | 2 | 2.5 |
| Example 7 | 250 | 2 | 3.0 |
| Comparative Example 1 | 170 | 2 | 1.3 |
| Comparative Example 2 | 170 | 2 | 2.0 |
| Comparative Example 3 | 230 | 2 | 0.3 |
| Comparative Example 4 | 250 | 2 | 3.0 |

As shown in Table 1 above, it was found that the salt rejection was as high as 97% or more and the permeate flux was as high as 35 L/m²hr or more in the range satisfying all conditions that the thin film type polyolefin-based microporous membrane as a support, the space ratio of the polyolefin-based microporous membrane was 20 to 70%, the maximum pore size measured by the bubble point method was 0.1 μl or less, and the product of the tensile strength and the thickness in at least one of the transverse direction and the longitudinal direction was 0.3 kgf/cm or more.

As shown in Comparative Examples 5 and 6, it was found that when the hydrophilization was not performed, the salt rejection and the permeate flux were very low even if physical properties of the microporous membrane were same.

1. A reverse osmosis membrane comprising:
a polyamide active layer formed on a hydrophilized polyolefin-based microporous membrane,
wherein, the polyolefin-based microporous membrane has a space ratio of 20 to 70%, a maximum pore size measured by a bubble point method of 0.1 μm or less, and a product of a tensile strength and a thickness in at least one of a transverse direction and a longitudinal direction of 0.3 kgf/cm or more.

2. The reverse osmosis membrane of claim 1, wherein the polyolefin-based microporous membrane has a contact angle of water of 90 degrees or less.

3. The reverse osmosis membrane of claim 1, wherein the polyolefin-based microporous membrane is a film or a sheet.

4. The reverse osmosis membrane of claim 1, wherein the polyolefin-based microporous membrane is selected from a single layer microporous membrane formed of any one selected from a polyethylene, a polypropylene, and a mixture thereof;
a composite microporous membrane having two or more layers in which the polyethylene and the polypropylene are alternately stacked in two or more layers; and
a multilayer microporous membrane in which the polyethylene or the polypropylene is stacked in two or more layers.

5. The reverse osmosis membrane of claim 1, wherein the hydrophilization is performed by any one method selected from formation of a coating layer by applying any one selected from a surfactant, a surface active agent, a wetting agent, a polymer solution containing inorganic particles, and a hydrophilic polymer, plasma treatment, UV-ozone treatment, corona discharge, surface foaming, and grafting with a hydrophilic polymer by plasma treatment.

6. The reverse osmosis membrane of claim 1, wherein the polyamide active layer is formed by interfacial polymerization of an aqueous solution containing a polyfunctional amine and an organic solution containing a polyfunctional acyl halide.

7. The reverse osmosis membrane of claim 1, wherein the reverse osmosis membrane has a salt rejection of 97% or more and a permeate flux of 35 L/m²hr or more.
